(19) United States
(12) Patent Application Publication
(10) Pub. No.: US 2019/0348728 A1
(43) Pub. Date: Nov. 14, 2019

(54) BATTERY PACK

(71) Applicant: HONDA MOTOR CO., LTD., Tokyo (JP)

(72) Inventors: Masao KAWATA, Saitama (JP); Atsushi SAKURAI, Saitama (JP)

(73) Assignee: HONDA MOTOR CO., LTD., Tokyo (JP)

(21) Appl. No.: 16/397,188

(22) Filed: Apr. 29, 2019

(30) Foreign Application Priority Data
May 9, 2018 (JP) 2018-090704

(51) Int. Cl. H01M 10/6568; H01M 2/10; H01M 10/613; H01M 10/6554; H01M 10/625

(52) U.S. Cl. CPC H01M 10/6568; H01M 2/1077; H01M 10/625; H01M 10/6554; H01M 10/613

(57) ABSTRACT

A battery pack 10 includes a battery module 1 and a cooling mechanism 40 configured to cool the battery module. The battery module 1 includes a cell stack 2 formed by stacking a plurality of cells 21, and a bottom plate 6 on which the cell stack 2 is mounted. The cooling mechanism 40 is a refrigerant flow path 41 configured to be passed through by a liquid medium W, and the bottom plate 6 constitutes at least a part of the refrigerant flow path 41. The battery pack is capable of efficiently cooling a battery module while preventing increase in a number of components.

### CROSS-REFERENCE TO RELATED APPLICATIONS

This application is based on and claims priority under 35 USC 119 from Japanese Patent Application No. 2018-090704 filed on May 9, 2018.

### TECHNICAL FIELD

The present invention relates to a battery pack mounted on an electric vehicle or the like.

### BACKGROUND ART

In related art, a battery pack is mounted on an electric vehicle or the like. The battery pack is configured by housing a battery module in a case and the battery module includes a cell stack formed by stacking a plurality of cells. The cells tend to degrade when they are in a high temperature state, and thus need to be cooled. For example, in JP-A-2013-122818, a battery module is installed on top of a cooling plate in which a refrigerant is to be supplied.

### SUMMARY

However, in JP-A-2013-122818, since the cooling plate is separate from the battery module, there is a problem that the battery module cannot be directly cooled by the refrigerant, and the cooling efficiency is not good.

Accordingly, an aspect of the present invention provides a battery pack capable of cooling a battery module efficiently while preventing increase in a number of components.

An embodiment of the present invention relates to:

a battery pack including:

a battery module including a cell stack formed by stacking a plurality of cells, and a bottom plate on which the cell stack is mounted; and

a cooling mechanism configured to cool the battery module,

wherein the cooling mechanism is a refrigerant flow path through which a liquid medium is to pass, and

wherein the bottom plate constitutes at least a part of the refrigerant flow path.

According to the above configuration, since the cooling mechanism is a refrigerant flow path configured to be passed through by a liquid medium, and the bottom plate on which the cell stack is mounted constitutes at least a part of the refrigerant flow path, it is possible to cool the battery module efficiently while preventing increase in the number of components.

### BRIEF DESCRIPTION OF DRAWINGS

FIG. 1 is a cross-sectional view of a battery pack according to a first embodiment of the present invention.

FIG. 2 is a perspective view of a battery module and a plate-shaped member of the battery pack of FIG. 1 as viewed obliquely from above.

FIG. 3 is an exploded perspective view of the battery module and the plate-shaped member shown in FIG. 2 as viewed obliquely from below FIG. 4 is a cross-sectional view of a battery pack according to a second embodiment of the present invention.

FIG. 5 is a perspective view of a battery module and a plate-shaped member of the battery pack of FIG. 4 as viewed obliquely from above.

FIG. 6 is a cross-sectional view of a battery pack according to a third embodiment of the present invention.

FIG. 7 is a conceptual diagram of a cooling mechanism of the battery pack shown in FIG. 6.

FIG. 8 is a conceptual diagram of a cooling mechanism of a battery pack according to a fourth embodiment of the present invention.

### DESCRIPTION OF EMBODIMENTS

Embodiments of a battery pack of the present invention will be described below with reference to the drawings. The drawings are to be viewed in a direction of the reference numerals.

### First Embodiment

<Battery Pack>

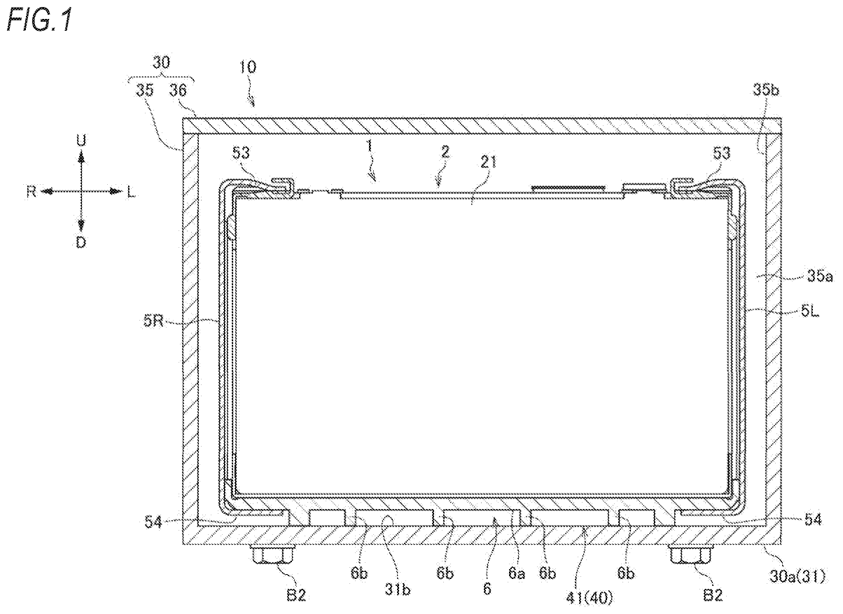

As shown in FIG. 1, a battery pack 10 according to a first embodiment of the present invention includes a battery module 1, a battery case 30 that houses the battery module 1, and a cooling mechanism 40 that cools the battery module 1.

<Battery Case>

The battery case 30 includes a case body 35 in which a module housing portion 35a is formed, and a case cover 36 that seals an opening portion 35b of the case body 35. By fixing the battery module 1 and a plate-shaped member 31 constituting a bottom portion 30a of the case body 35, the battery module 1 is housed in the module housing portion 35a of the battery case 30.

<Battery Module>

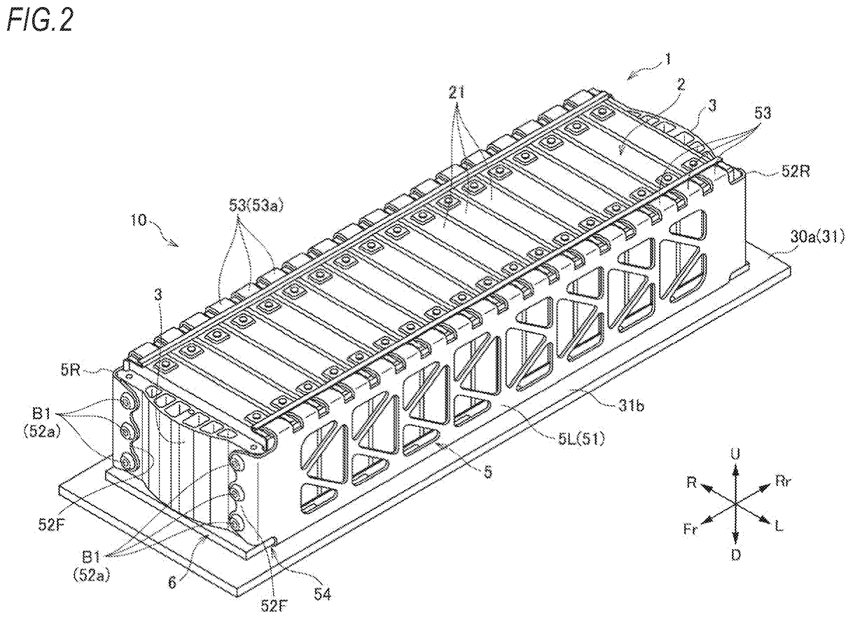

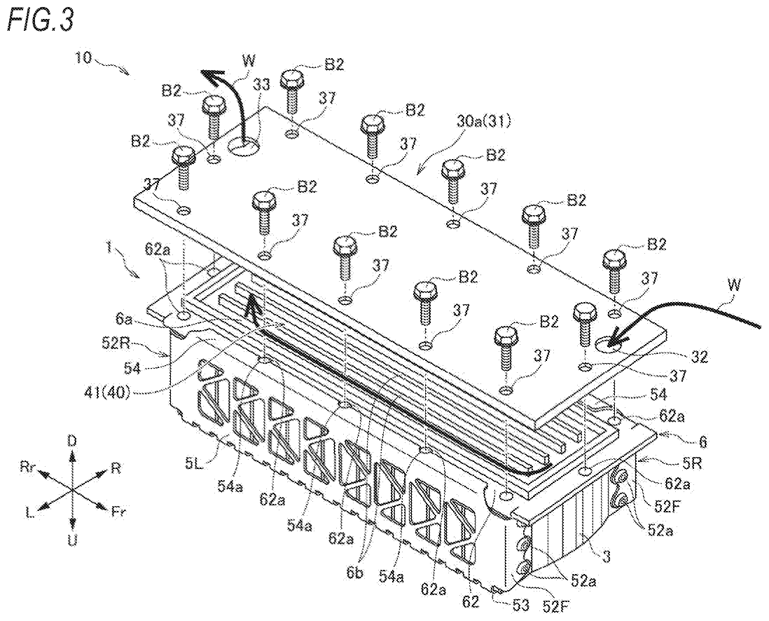

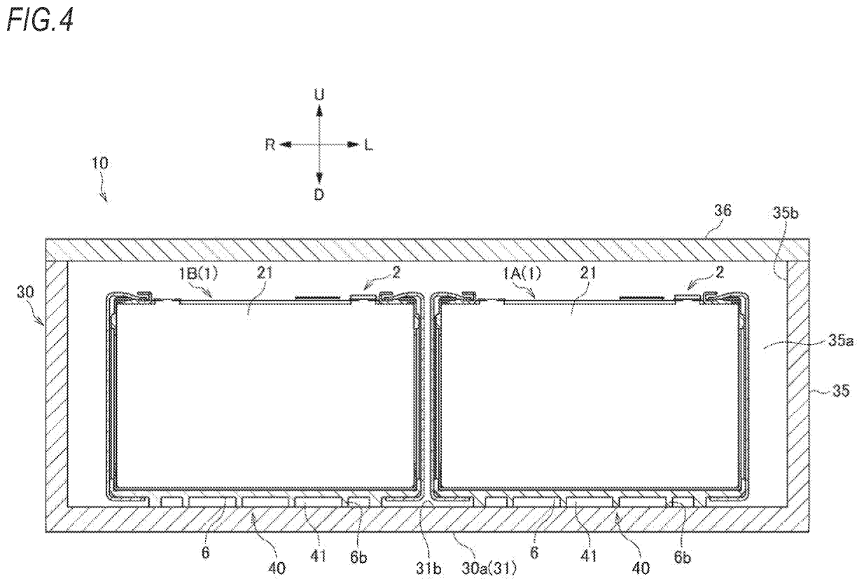

As shown in FIGS. 2 and 3, the battery module 1 includes: a cell stack 2 being configured by stacking a plurality of cells 21 in a front-rear direction and having a front surface, a rear surface, a left surface, a right surface, an upper surface, and a lower surface; a pair of end plates 3 disposed on the front surface and the rear surface of the cell stack 2 respectively; a side plates 5 connecting the pair of end plates 3; and a bottom plate 6 disposed on the lower surface of the cell stack 2. The side plates 5 includes a right side plate 5R disposed on the right surface of the cell stack 2 and a left side plate 5L disposed on the left surface of the cell stack 2.

In the present specification or the like, in order to simplify and clarify the description, a stacking direction of the cells 21 is defined as the front-rear direction, and directions orthogonal to the stacking direction of the cells 21 are defined as a left-right direction and an upper-lower direction, which are independent from a front-rear direction of a product on which the battery module 1 is mounted. In other words, in a case where the battery module 1 is mounted on a vehicle, the stacking direction of the cells 21 may coincide with a front-rear direction of the vehicle, may be an upper-lower direction or a left-right direction of the vehicle, or may be a direction inclined from these directions. In the drawings, a front side of the battery module 1 is denoted by Fr, a rear side by Rr, a left side by L, a right side by R, an upper side by U, and a lower side by D, respectively.

(Cell Stack)

The cell stack 2 is configured by alternately stacking a plurality of cells 21 and insulating members (not shown) in the front-rear direction. The pair of end plates 3 are disposed on the front surface and the rear surface of the cell stack 2, respectively, and the bottom plate 6 is disposed on the lower surface of the cell stack 2. The right side plate 5R and the left side plate 5L are arranged on the left and right surfaces of the cell stack 2 in an insulated state with small gaps therebetween, respectively.

It is known that the cells 21 expand due to temperature change and aging degradation. Each of the cells 21 has a rectangular parallelepiped shape whose length in the upper-lower direction is longer than the length in the front-rear direction and whose length in the left-right direction is longer than the length in the upper-lower direction. Therefore, areas of the front surface and the rear surface of the cell 21 are greatly larger than areas of the left surface, the right surface, the upper surface, and the lower surface, and left-right center portions and upper-lower center portions on the front surface and the rear surface of the cell 21 are likely to expand.

(End Plates)

The pair of end plates 3 respectively abut the front surface and the rear surface of the cell stack 2, and receive a load in the cell stacking direction of the cell stack 2. A load in the cell stacking direction of the cell stack 2 is mainly caused by expansion of the cell 21 due to temperature change or aging degradation, and as described above, since the left-right center portions and the upper-lower center portions on the front surface and the rear surface of the cell 21 are likely to expand, a large load is applied to the left-right center portions and the upper-lower center portions of the end plates 3.

The end plates 3 are formed using an aluminum extrusion material. Since the end plates 3 receive a large load in the cell stacking direction from the cell stack 2, inner surfaces of the end plates 3 abutting the cell stack 2 are flat, whereas outer surfaces of the end plates 3 without abutting the cell stack 2 have a shape bulging outward. A plurality of (three in this embodiment) screw holes (not shown), to which bolts B1 for fastening the left side plate 5L and the right side plate 5R are attached respectively, are provided near the left and right ends of each end plate 3.

(Side Plates)

The left side plate 5L, and the right side plate 5R are formed by pressing a metal plate material, and respectively include: side plate bodies 51 along the left surface or the right surface of the cell stack 2; front flange portions 52F extending in a direction approaching each other from front ends of the side plate bodies 51 along a front surface of the end plate 3 on the front side; rear flange portions 52R extending in a direction approaching each other from rear ends of the side plate bodies 51 along a rear surface of the end plate 3 on the rear side; upper flange portions 53 extending in a direction approaching each other from upper ends of the side plate bodies 51 along an upper surface of the cell stack 2; and lower flange portions 54 extending in a direction approaching each other from lower ends of the side plate bodies 51 along a lower surface 6a of the bottom plate 6.

Each of the front flange portions 52F and the rear flange portions 52R is provided with a plurality of fastening portions 52a fastened to the end plate 3 on the front side or the end plate 3 on the rear side, via the bolts B1. The fastening portions 52a respectively have round holes through which the bolts B1 are inserted, and by screwing the bolts B1 inserted through the round holes into the screw holes of the end plate 3 on the front side or the end plate 3 on the rear side, the front flange portions 52F and the rear flange portions 52R are fastened to the end plate 3 on the front side or the end plate 3 on the rear side. Thus, the cell stack 2 and the pair of end plates 3 are held in the cell stacking direction by the front flange portions 52F and the rear flange portions 52R of the left side plate 5L and the right side plate 5R.

The upper flange portions 53 and the lower flange portions 54 clamp the cell stack 2 and the bottom plate 6 from the upper and lower directions at a left end portion and a right end portion of the cell stack 2. Each of the upper flange portions 53 includes a plurality of elastic pieces 53a arranged in the front-rear direction, and the number and positions of the elastic pieces 53a correspond to the number and positions of the cells 21 stacked in the front-rear direction.

Each of the lower flange portions 54 is provided with a plurality of fastening portions 54a fastened to the bottom plate 6 via bolts B2. Thus, the left side plate 5L and the right side plate 5R constituting the side plates 5, and the bottom plate 6 are connected integrally.

(Bottom Plate)

The bottom plate 6 is a plate member which mounts the cell stack 2. The bottom plate 6 extends along the lower surfaces of the cell stack 2 and the end plates 3 and has a rectangular shape in a plan view. A peripheral portion 62 of the bottom plate 6 is provided with a plurality of screw holes (female screws) 62a to which the bolts B2 are attached. The bottom portion 30a (the plate-shaped member 31) of the case body 35 to which the bottom plate 6 is fixed is provided with, at positions overlapping the screw holes 62a of the bottom plate 6, the same number of through holes 37 as the number of the screw holes 62a of the bottom plate 6.

<Cooling Mechanism>

The bottom plate 6 constitutes a part of a refrigerant flow path 41 serving as the cooling mechanism 40. More specifically, the refrigerant flow path 41 through which a liquid medium W is to pass is provided by the lower surface 6a of the bottom plate 6 and an upper surface 31b of the plate-shaped member 31. The refrigerant flow path 41 is formed on the lower surface 6a of the bottom plate 6, and occupies most of the bottom plate 6 except for the peripheral portion 62. A plurality of convex portions 6b projecting into the refrigerant flow path 41 are provided from the lower surface 6a of the bottom plate 6.

A refrigerant inlet portion 32 serving as an inlet of the liquid medium W to the refrigerant flow path 41 is provided at one end portion (front portion) of the plate-shaped member 31 in the front-rear direction (the stacking direction of the cells 21). A refrigerant outlet portion 33 serving as an outlet of the liquid medium W from the refrigerant flow path 41 is provided at the other end portion (rear portion) of the plate-shaped member 31 in the front-rear direction. A seal member (not shown) is provided between the plate-shaped member 31 and the bottom plate 6 to seal between the plate-shaped member 31 and the bottom plate 6 around an entire periphery.

The battery pack 10 according to the first embodiment configured as described above is obtained by matching the side plates 5, the bottom plate 6, and the plate-shaped member 31 with each other, then inserting the bolts B2 into the through holes 37 of the plate-shaped member 31 from below, and fastening the bolt B2 into the screw holes 62a of the bottom plate 6, so as to integrally join the side plates 5, the bottom plate 6, and the plate-shaped member 31 with the bolts B2. Then, the refrigerant flow path 41 through which the liquid medium WV flows is formed by the bottom plate 6 and the plate-shaped member 31 which are joined to each other.

According to the first embodiment, since the bottom plate 6, which is a component of the battery module 1, constitutes at least a part of the refrigerant flow path 41, it is possible to cool the battery module 1 efficiently with the liquid medium W while preventing increase in the number of components. Further, since the plurality of convex portions 6b are provided on the lower surface 6a of the bottom plate 6, a contact area between the liquid medium W and the bottom plate 6 increases, which further improves cooling performance.

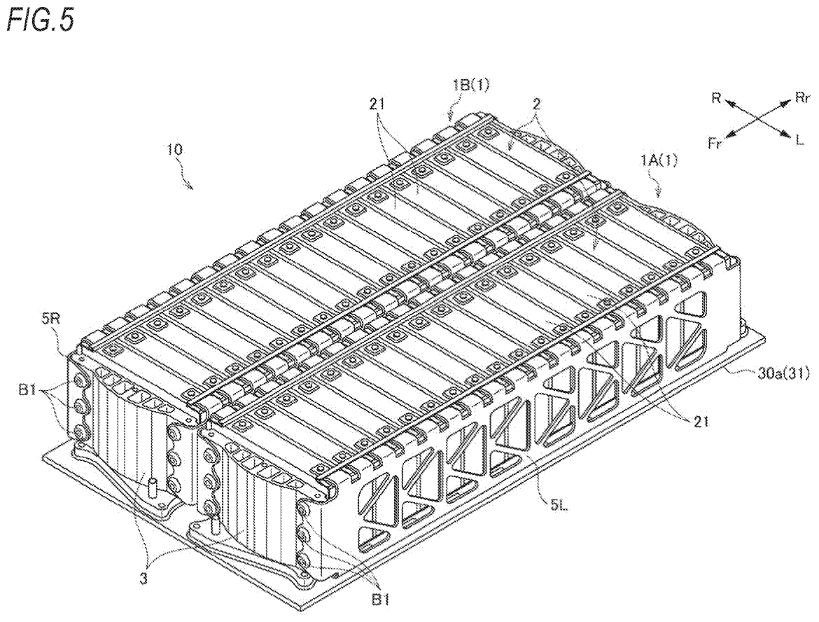

Next, battery packs of other embodiments of the present invention are described with reference to FIGS. 4 to 8. Note that only differences from the first embodiment will be described, and the description of the first embodiment is incorporated by denoting the same configurations as those of the first embodiment with the same reference numerals as in the first embodiment.

### Second Embodiment

As shown in FIG. 4, in the battery pack 10 according to the second embodiment, a first battery module 1A and a second battery module 1B are housed in the battery case 30. The two battery modules 1 are arranged on the plate-shaped member 31 in the left-right direction (a direction orthogonal to the stacking direction of the cells 21).

According to the battery pack 10 of the second embodiment configured as described above, since refrigerant flow paths 41 are formed by the bottom plates 6 of the two battery modules 1A and 1B and the plate-shaped member 31 constituting the bottom portion 30a of the battery case 30, the number of components of the battery pack 10 can be reduced, and the two battery modules 1A and 1B can be handled integrally.

### Third Embodiment

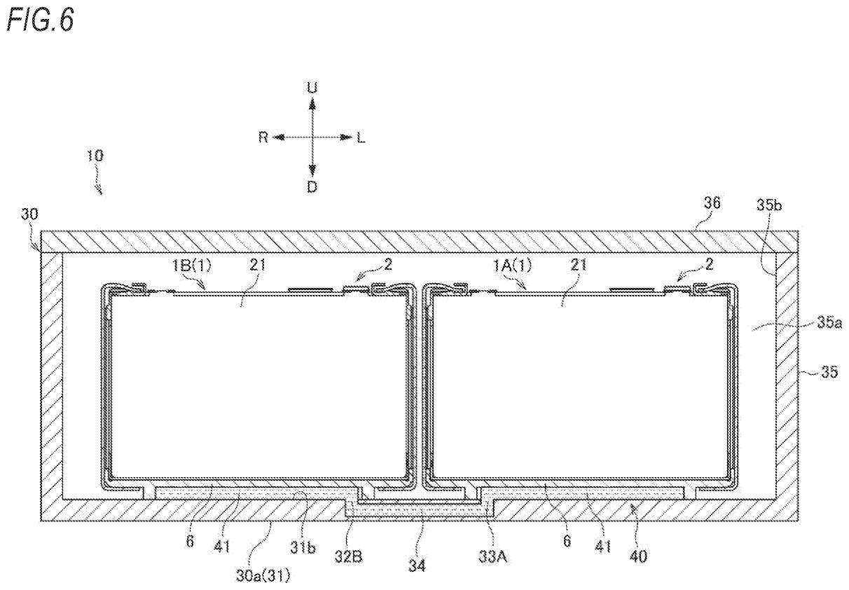

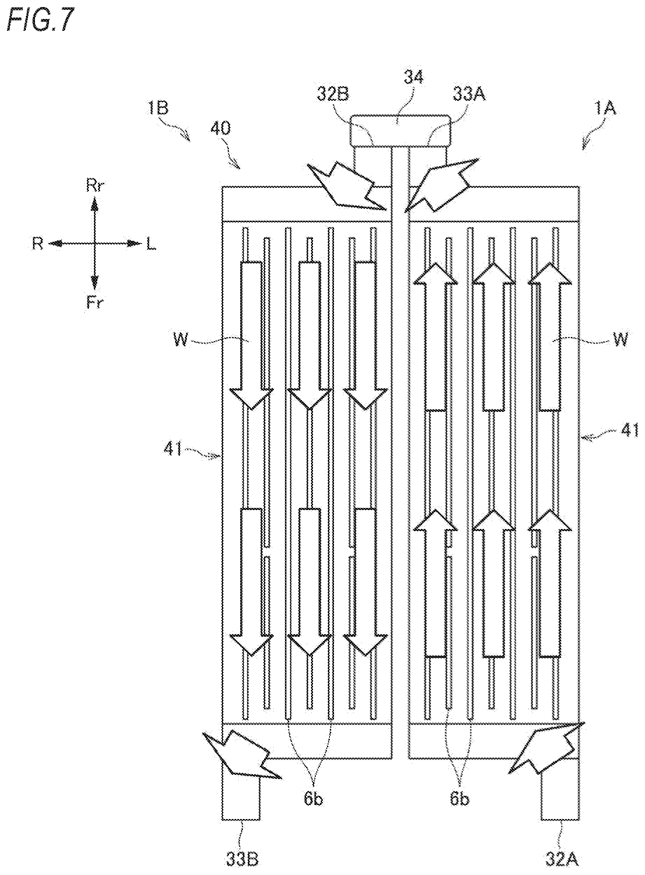

As shown in FIGS. 6 and 7, in the battery pack 10 according to the third embodiment, the refrigerant flow path 41 of the first battery module 1A and the refrigerant flow path 41 of the second battery module 1B are connected. More specifically, the first battery module 1A includes a first refrigerant inlet portion 32A provided at one end portion (a front portion) in the front-rear direction (the stacking direction of the cells 21) and a first refrigerant outlet portion 33A provided at the other end portion (a rear portion) in the front-rear direction; and the second battery module 1B includes a second refrigerant inlet portion 32B provided at the other end portion (rear portion) in the front-rear direction and a second refrigerant outlet portion 33B provided at the one end portion (front portion) in the front-rear direction. The first refrigerant outlet portion 33A is provided on the second battery module 1B side in the left-right direction (the direction orthogonal to the stacking direction), and the second refrigerant inlet portion 32B is provided on the first battery module 1A side in the left-right direction. The first refrigerant outlet portion 33A and the second refrigerant inlet portion 32B are connected by a connection flow path 34 disposed inside the plate-shaped member 31. In each of the refrigerant flow paths 41, the plurality of convex portions 6b extending along the front-rear direction are arranged at equal intervals in the left-right direction.

According to the battery pack 10 of the third embodiment, since the first refrigerant outlet portion 33A and the second refrigerant inlet portion 32B are connected, the refrigerant flow path 41 of the first battery module 1A and the refrigerant flow path 41 of the second battery module 1B can be connected in series. Moreover, since both the first refrigerant outlet portion 33A and the second refrigerant inlet portion 32B are on the same side in the front-rear direction (the other end portion), and are on sides close to each other in the left-right direction, the connection flow path 34 can be short.

Since the connection flow path 34 connecting the first refrigerant outlet portion 33A and the second refrigerant inlet portion 32B is provided in the plate-shaped member 31, a pipe for constituting the connection flow path 34 is unnecessary, and a space on the bottom portion 30a of the battery case 30 can be effectively used as compared with a case where the connection flow path 34 is constituted by a pipe. Further, since the convex portions 6b are provided in each of the refrigerant flow paths 41 along the front-rear direction, heat exchange efficiency between the liquid medium W and the bottom plates 6 can be improved without inhibiting flow of the liquid medium W, which improves the cooling efficiency. In addition, the plurality of convex portions 6b provided to the bottom plates 6 of the first battery module 1A and the second battery module 1B along the front-rear direction serve as ribs to increase strength, and the first battery module 1A and the second battery module 1B can be prevented from bending in the upper-lower direction.

### Fourth Embodiment

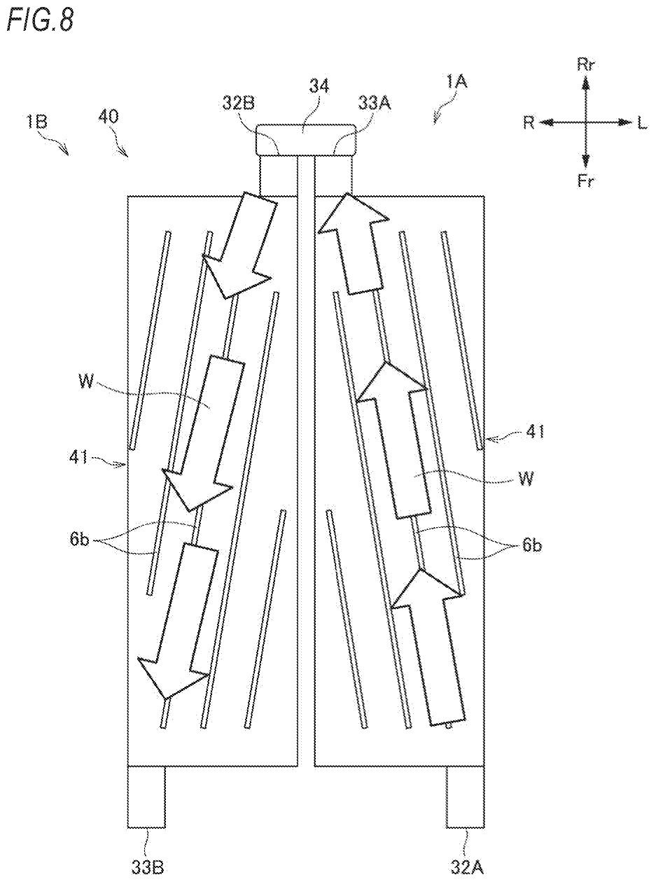

As shown in FIG. 8, in the battery pack 10 according to the fourth embodiment, the plurality of convex portions 6b extend in a manner inclined with respect to the front-rear direction. More specifically, the plurality of convex portions 6b of the first battery module 1A are inclined with respect to the front-rear direction from the first refrigerant inlet portion 32A toward the first refrigerant outlet portion 33A, and the plurality of convex portions 6b of the second battery module 1B are inclined with respect to the front-rear direction from the second refrigerant inlet portion 32B toward the second refrigerant outlet portion 33B. According to the fourth embodiment, flow path resistance of the refrigerant flow path 41 can be reduced, which improves the cooling efficiency.

The present invention is not limited to the embodiments described above, and modifications, improvements, or the like can be made as appropriate. For example, in the above embodiment, although the plurality of convex portions 6b are provided on the lower surfaces 6a of the bottom plates 6, the plurality of convex portions 6b may also be provided on the upper surface 31b of the plate-shaped member 31.

In the above embodiment, although the plate-shaped member 31 forming the refrigerant flow path 41 together with the bottom plates 6 constitutes the bottom portion 30a of the battery case 30, the plate-shaped member 31 may be a member other than a member constituting the bottom portion 30a of the battery case 30.

In the above embodiment, although the side plates 5, the bottom plates 6, and the plate-shaped member 31 are fastened together by common bolts B2, for exanmple, the side plate 5 and the bottom plate 6 may also be fixed by bolts other than the bolts B2.

At least the following matters are described in the present specification. Corresponding components in the above-described embodiments are shown in parentheses, without being limited thereto.

(1) A battery pack (the battery pack 10) includes:

a battery module (the battery module 1) including a cell stack (the cell stack 2) formed by stacking a plurality of cells (the cells 21), and a bottom plate (the bottom plate 6) on which the cell stack is mounted; and

a cooling mechanism (the cooling mechanism 40) configured to cool the battery module,

the cooling mechanism is a refrigerant flow path (the refrigerant flow path 41) configured to be passed through by a liquid medium (the liquid medium W), and

the bottom plate constitutes at least a part of the refrigerant flow path.

According to (1), since the cooling mechanism is a refrigerant flow path configured to be passed through by a liquid medium, and the bottom plate on which the cell stack is mounted constitutes at least a part of the refrigerant flow path, it is possible to cool the battery module while preventing increase in the number of components.

(2) In the battery pack according to (1), the battery pack further includes:

a plate-shaped member (the plate-shaped member 31) disposed below the bottom plate,

the refrigerant flow path is formed by an upper surface (the upper surface 31b) of the plate-shaped member and a lower surface (the lower surface 6a) of the bottom plate, and

a plurality of convex portions (the convex portions 6b) are provided on at least one of the upper surface of the plate-shaped member and the lower surface of the bottom plate.

According to (2), a refrigerant flow path can be easily formed by forming the refrigerant flow path with the bottom plate and the plate-shaped member arranged below the bottom plate. Moreover, since a plurality of convex portions are provided on at least one of the upper surface of the plate-shaped member and the lower surface of the bottom plate, a contact area with the liquid refrigerant increases, which improves the cooling performance.

(3) In the battery pack according to (1),

the plurality of convex portions protrude downward from the lower surface of the bottom plate, and are provided along a stacking direction of the cells.

According to (3), the cooling performance of the battery module is further improved. Also, bending of the battery module in the upper-lower direction can be prevented.

(4) In the battery pack according to (2) or (3),

at least two battery modules (the first battery module 1A and the second battery module 1B) are disposed on the plate-shaped member.

According to (4), the at least two battery modules arranged on the plate-shaped member can be integrally handled as an assembly.

(5) In the battery pack according to (4),

the plate-shaped member is configured as a bottom portion of a battery case that houses the battery module.

According to (5), the refrigerant flow path is formed between the bottom plate of the battery module and the battery case that houses the battery module, which reduces the number of components.

(6) In the battery pack according to (4) or (5),

the at least two battery modules include a first battery module (the first battery module 1A) and a second battery module (the second battery module 1B) arranged in a direction orthogonal to the stacking direction of the cells,

the first battery module includes a first refrigerant inlet portion (the first refrigerant inlet portion 32A) provided at one end portion in the stacking direction and a first refrigerant outlet portion (the first refrigerant outlet portion 33A) provided at the other end portion in the stacking direction,

the second battery module includes a second refrigerant inlet portion (the second refrigerant inlet portion 32B) provided at the other end portion in the stacking direction and a second refrigerant outlet portion (the second refrigerant outlet portion 33B) provided at the one end portion in the stacking direction,

the first refrigerant outlet portion is provided on the second battery module side in the direction orthogonal to the stacking direction,

the second refrigerant inlet portion is provided on the first battery module side in the direction orthogonal to the stacking direction, and

the first refrigerant outlet portion and the second refrigerant inlet portion are connected by a connection flow path (the connection flow path 34).

According to (6), since the first refrigerant outlet portion and the second refrigerant inlet portion are connected by the connection flow path, the refrigerant flow path of the first battery module and the refrigerant flow path of the second battery module can be connected in series. Moreover, since both the first refrigerant outlet portion and the second refrigerant inlet portion are on the same side in the stacking direction, and are on sides close to each other in the direction orthogonal to the stacking direction, the connection flow path can be made short.

(7) In the battery pack according to (6),

the first refrigerant inlet portion is provided on a side opposite to the second battery module side in the direction orthogonal to the stacking direction,

the second refrigerant outlet portion is provided on a side opposite to the first battery module side in the direction orthogonal to the stacking direction, and

the plurality of convex portions of the first battery module are inclined with respect to the stacking direction from the first refrigerant inlet portion toward the first refrigerant outlet portion, and

the plurality of convex portions of the second battery module are inclined with respect to the stacking direction from the second refrigerant inlet portion toward the second refrigerant outlet portion.

According to (7), the flow path resistance of the refrigerant flow path can be reduced.

(8) In the battery pack according to (6) or (7),

the connection flow path is formed on the bottom portion (the bottom portion 30a) of the battery case (the battery case 30) that houses the battery module.

According to (8), piping for constituting the connection flow path is unnecessary, and the space on the bottom portion of the battery case can be effectively used as compared with a case where the connection flow path is constituted by a pipe.

1. A battery pack comprising:
a battery module including a cell stack formed by stacking a plurality of cells, and a bottom plate on which the cell stack is mounted; and
a cooling mechanism configured to cool the battery module,
wherein the cooling mechanism is a refrigerant flow path through which liquid medium is to pass, and
wherein the bottom plate constitutes at least a part of the refrigerant flow path.

2. The battery pack according to claim 1, further comprising:
a plate-shaped member disposed below the bottom plate,
wherein the refrigerant flow path is formed by an upper surface of the plate-shaped member and a lower surface of the bottom plate, and
wherein a plurality of convex portions are provided on at least one of the upper surface of the plate-shaped member and the lower surface of the bottom plate.

3. The battery pack according to claim 2,
wherein the plurality of convex portions protrude downward from the lower surface of the bottom plate, and are provided along a stacking direction of the cells.

4. The battery pack according to claim 2,
wherein at least two battery modules are disposed on the plate-shaped member.

5. The battery pack according to claim 4,
wherein the plate-shaped member is configured as a bottom portion of a battery case that houses the battery module.

6. The battery pack according to claim 4,
wherein the at least two battery modules include a first battery module and a second battery module which are arranged in a direction orthogonal to a stacking direction of the cells,
wherein the first battery module includes a first refrigerant inlet portion provided at one end portion in the stacking direction and a first refrigerant outlet portion provided at the other end portion in the stacking direction,
wherein the second battery module includes a second refrigerant inlet portion provided at the other end portion in the stacking direction and a second refrigerant outlet portion provided at the one end portion in the stacking direction,
wherein the first refrigerant outlet portion is provided on the second battery module side in the direction orthogonal to the stacking direction,
wherein the second refrigerant inlet portion is provided on the first battery module side in the direction orthogonal to the stacking direction, and
wherein the first refrigerant outlet portion and the second refrigerant inlet portion are connected by a connection flow path.

7. The battery pack according to claim 6,
wherein the first refrigerant inlet portion is provided on a side opposite to the second battery module side in the direction orthogonal to the stacking direction,
wherein the second refrigerant outlet portion is provided on a side opposite to the first battery module side in the direction orthogonal to the stacking direction, and
wherein the plurality of convex portions of the first battery module are inclined with respect to the stacking direction from the first refrigerant inlet portion toward the first refrigerant outlet portion, and
wherein the plurality of convex portions of the second battery module are inclined with respect to the stacking direction from the second refrigerant inlet portion toward the second refrigerant outlet portion.

8. The battery pack according to claim 6,
wherein the connection flow path is formed on a bottom portion of a battery case that houses the battery module.

9. The battery pack according to claim 5,
wherein the at least two battery modules include a first battery module and a second battery module which are arranged in a direction orthogonal to a stacking direction of the cells,
wherein the first battery module includes a first refrigerant inlet portion provided at one end portion in the stacking direction and a first refrigerant outlet portion provided at the other end portion in the stacking direction,
wherein the second battery module includes a second refrigerant inlet portion provided at the other end portion in the stacking direction and a second refrigerant outlet portion provided at the one end portion in the stacking direction,
wherein the first refrigerant outlet portion is provided on the second battery module side in the direction orthogonal to the stacking direction,
wherein the second refrigerant inlet portion is provided on the first battery module side in the direction orthogonal to the stacking direction, and
wherein the first refrigerant outlet portion and the second refrigerant inlet portion are connected by a connection flow path.

10. The battery pack according to claim 9,
wherein the first refrigerant inlet portion is provided on a side opposite to the second battery module side in the direction orthogonal to the stacking direction,
wherein the second refrigerant outlet portion is provided on a side opposite to the first battery module side in the direction orthogonal to the stacking direction, and
wherein the plurality of convex portions of the first battery module are inclined with respect to the stacking direction from the first refrigerant inlet portion toward the first refrigerant outlet portion, and
wherein the plurality of convex portions of the second battery module are inclined with respect to the stacking direction from the second refrigerant inlet portion toward the second refrigerant outlet portion.

11. The battery pack according to claim 9,
wherein the connection flow path is formed on a bottom portion of a battery case that houses the battery module.
